(19) United States
(12) Patent Application Publication
(10) Pub. No.: US 2026/0277507 A1
(43) Pub. Date: Sep. 17, 2026

(54) PRINTING SYSTEM AND PRINTING METHOD

(71) Applicant: Shinya NOHDOMI, Kanagawa (JP)

(72) Inventor: Shinya NOHDOMI, Kanagawa (JP)

(21) Appl. No.: 19/554,668

(22) Filed: Mar. 3, 2026

(30) Foreign Application Priority Data
Mar. 11, 2025 (JP) 2025-038779

(51) Int. Cl. G06F 3/12; G03G 15/00; G06T 7/00

(52) U.S. Cl. CPC G06F 3/121; G03G 15/5016; G03G 15/6573; G06F 3/1234; G06T 7/001; G03G 2215/00616; G06T 2207/30144

(57) ABSTRACT

A printing system includes a printer to print image data to output a printed material; an inspection apparatus including a reader to read the printed material output from the printer to acquire an inspection target image; and circuitry configured to detect defects, according to multiple defect detection levels, from the inspection target image on the printed material based on the inspection target image and a master image to be compared with the inspection target image; determine, for each of the defects, one of the multiple defect detection levels; and display, on the inspection target image, a mark indicating a position of each of the defects in the inspection target image on the printed material and having a color changed according to the one of the multiple defect detection levels determined.

### CROSS-REFERENCE TO RELATED APPLICATIONS

This patent application is based on and claims priority pursuant to 35 U.S.C. § 119(a) to Japanese Patent Application No. 2025-038779, filed on Mar. 11, 2025, in the Japan Patent Office, the entire disclosure of which is hereby incorporated by reference herein.

### BACKGROUND

### Technical Field

The present disclosure relates to a printing system and a printing method.

### Background Art

A technique has been developed that, when notifying a user of defect-detection results, indicates the positions of defects detected at a preset defect-detection level (i.e., defect criteria) on a captured image by using a rectangular frame or another indicator, and displays each defect-detection level. This technique also changes the defect-detection level and switches the display to the detection results detected using the changed defect-detection level. With these functions, this technique enables easy adjustment of the defect-detection level.

### SUMMARY

The present disclosure herein provides a printing system includes a printer to print image data to output a printed material; an inspection apparatus including a reader to read the printed material output from the printer to acquire an inspection target image; and circuitry configured to detect defects, according to multiple defect detection levels, from the inspection target image on the printed material based on the inspection target image and a master image to be compared with the inspection target image; determine, for each of the defects, one of the multiple defect detection levels; and display, on the inspection target image, a mark indicating a position of each of the defects in the inspection target image on the printed material and having a color changed according to the one of the multiple defect detection levels determined.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a diagram illustrating a configuration of a printer to which an inspection apparatus is connected;

FIG. 1B is a diagram illustrating a hardware configuration of a printing system;

FIG. 2 is a diagram illustrating a functional configuration of a digital front end (DFE) included in a printing system;

FIG. 3 is a diagram illustrating a functional configuration of a printer included in a printing system;

FIG. 4 is a diagram illustrating a configuration of an inspection apparatus;

FIG. 5 is a table indicating the contents of job management information;

FIG. 6 is a flowchart illustrating a process of detecting defects and displaying defect detection results in a printing system;

FIG. 7 is a defect information table that stores defect information of a defect detected in a printing system;

FIG. 8 is a diagram illustrating a screen displaying defect detection results in a printing system;

FIG. 9 is a diagram illustrating a screen displaying defect detection results in a printing system; and

FIG. 10 is a diagram illustrating a screen displaying defect detection results in a printing system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, the workload for adjusting the defect detection level can be reduced.

Embodiments of an inspection device applying a printing system, a printing apparatus, a printing method, and a program are described in detail below with reference to the accompanying drawings.

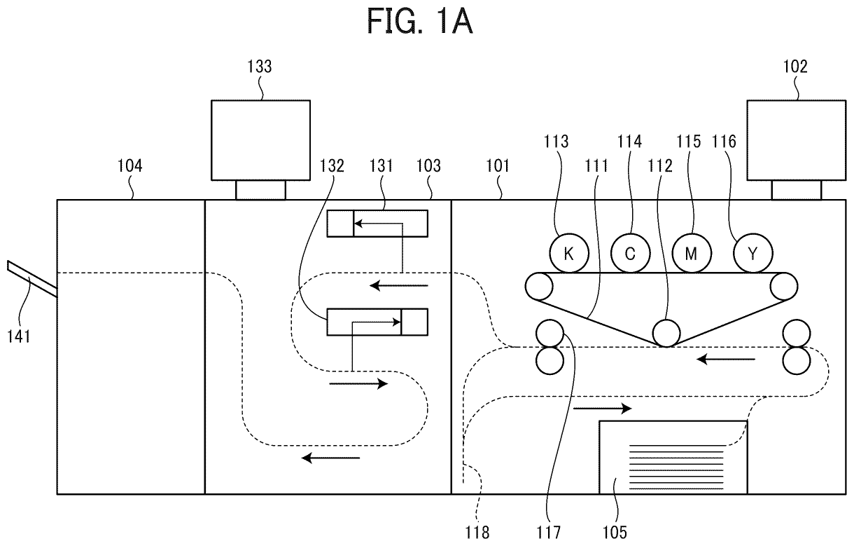

FIG. 1A is a diagram illustrating a configuration of a printer 101 to which an inspection apparatus 103 is connected. In the present embodiment, a printing system includes the printer 101, an operation unit 102 of the printer 101, an inspection apparatus 103, and a stacker 104.

The printer 101, which is an example of a printing apparatus, receives print information (a print job) containing a print image (a rasterized image (RIP image)) from an externally connected image generation controller, such as a digital front end (DFE). Alternatively, the printer 101 receives an instruction to execute a print job stored within the printer 101 itself. In accordance with the content of the print job, the printer 101 acquires a sheet from a sheet feeder 105 and conveys the sheet along the path indicated by the dotted line in the figure. The printer 101 superimposes Black (K), Cyan (C), Magenta (M), and Yellow (Y) toner images, formed on drums 113, 114, 115, and 116 respectively, onto a belt 111. The printer 101 then transfers the toner images onto a sheet conveyed by a roller 112, and fixes the images onto the sheet using a roller 117. For single-sided printing, the sheet is ejected directly to the inspection apparatus 103. For double-sided printing, the sheet is inverted via a reversing path 118, and toner images are transferred and fixed onto the opposite side before the sheet is ejected to the inspection apparatus 103.

The inspection apparatus 103 inspects a sheet or a print sheet output from the printer 101 and is equipped with an operation unit 133. The inspection apparatus 103 may not be equipped with the operation unit 133, and the operation unit 102 of the printer 101 may also serve as the operation unit for the inspection apparatus 103. Alternatively, a personal computer (PC) connected via a local area network (LAN) may serve as the operation panel for the inspection apparatus 103. The inspection apparatus 103 reads both sides of a sheet ejected from the printer 101 with reading devices 131 and 132, and ejects the sheet. The stacker 104 stacks the sheet ejected from the inspection apparatus 103 on a tray 141.

FIG. 1B is a diagram illustrating a hardware configuration of a printing system 9 according to an embodiment of the present disclosure. As illustrated in FIG. 1B, the printing system 9, such as a multi-function peripheral product/printer (MFP), includes a controller 910, a short-range communication circuit 920, an engine control unit 930, an operation panel 940 (for example, the operation units 102 and 133), and a network interface (I/F) 950.

The controller 910 includes a central processing unit (CPU) 901 as a processor, a system memory (MEM-P) 902, a north bridge (NB) 903, a south bridge (SB) 904, an application-specific integrated circuit (ASIC) 906, a local memory (MEM-C) 907 as a storage unit, a hard disk drive (HDD) controller 908, and a hard disk (HD) 909 as a storage unit. The NB 903 and the ASIC 906 are connected through an accelerated graphics port (AGP) bus 921.

The CPU 901 is a controller that controls the entire operation of the printing system 9, such as the MFP. The NB 903 connects the CPU 901 with the MEM-P 902, the SB 904, and the AGP bus 921. The NB 903 includes a memory controller for controlling reading or writing of various data with respect to the MEM-P 902, a peripheral component interconnect (PCI) master, and an AGP target.

The MEM-P 902 includes a read-only memory (ROM) 902a as a memory that stores program and data for enabling various functions of the controller 910. The MEM-P 902 further includes a random-access memory (RAM) 902b as a memory that deploys the program and data, or as a drawing memory that stores drawing data for printing. The program stored in the RAM 902b may be stored in any computer-readable recording medium, such as a compact disc-read-only memory (CD-ROM), compact disc-recordable (CD-R), or digital versatile disc (DVD), in an installable or executable file format and provided as a computer program product.

The SB 904 is a bridge that connects the NB 903 to a PCI device or a peripheral device. The ASIC 906 is an integrated circuit (IC) dedicated to an image processing use, and serves as a bridge that connects the AGP bus 921, a peripheral component interconnect (PCI) bus 922, the HDD controller 908, and the MEM-C 907 to each other. The ASIC 906 includes a PCI target, an AGP master, an arbiter (ARB) as a central processor of the ASIC 906, a memory controller to control the MEM-C 907, multiple direct memory access controllers (DMACs) that performs operations, such as rotating image data with hardware logic, and a PCI unit that transfers data between a scanner unit 931 and a printer unit 932 through the PCI bus 922. The ASIC 906 may be connected to a universal serial bus (USB) interface, or the Institute of Electrical and Electronics Engineers 1394 (IEEE1394) interface.

The MEM-C 907 is a local memory used as a buffer for image data to be copied or a code buffer. The HD 909 is a storage device for storing image data, font data used during printing, and forms. The HD 909 controls reading or writing of data with respect to the HD 909 under control of the CPU 901. The AGP bus 921 is a bus interface for a graphics accelerator card, which has been proposed to accelerate graphics processing. Through directly accessing the MEM-P 902 by high throughput, the speed of the graphics accelerator card increases.

Furthermore, the short-range communication circuit 920 includes a short-range communication circuit 920a. The short-range communication circuit 920 is a communication circuit that communicates in compliance with the near-field communication (NFC) or the Bluetooth (Registered Trademark).

Furthermore, the engine control unit 930 includes the scanner unit 931 corresponding to the reading device 131, 132) and the printer unit 932 corresponding to the printer 101. The operation panel 940 includes a display panel 940a and an operation panel 940b. The display panel 940a, such as a touch panel, displays a current setting data and a selection screen, and receives an input from an operator. The operation panel 940b includes a numeric keypad that receives setting data of image forming conditions such as density setting conditions, and a start key for receiving a copy start instruction. The controller 910 controls the entire operation of the printing system 9, such as the MFP. The controller 910 controls, for example, drawing, communication, and user inputs to the operation panel 940. The scanner unit 931 and the printer unit 932 each performs various image processing, such as error diffusion or gamma conversion.

In response to an instruction to select a specific application input via an application switch key on the operation panel 940, the printing system 9, such as an MFP, sequentially switches between and selects a document box function, a copy function, a print function, and a facsimile function. When the document box function is selected, the MFP operates in a document box mode. When the copier function is selected, the MFP operates in a copy mode. When the printer function is selected, the MFP operates in a printer mode. When the facsimile function is selected, the MFP operates in a facsimile mode.

The network I/F 950 is an interface that controls communication of data through the communication network 100. The short-range communication circuit 920 and the network I/F 950 are electrically connected to the application-specific integrated circuit (ASIC) 906 through the PCI bus 922.

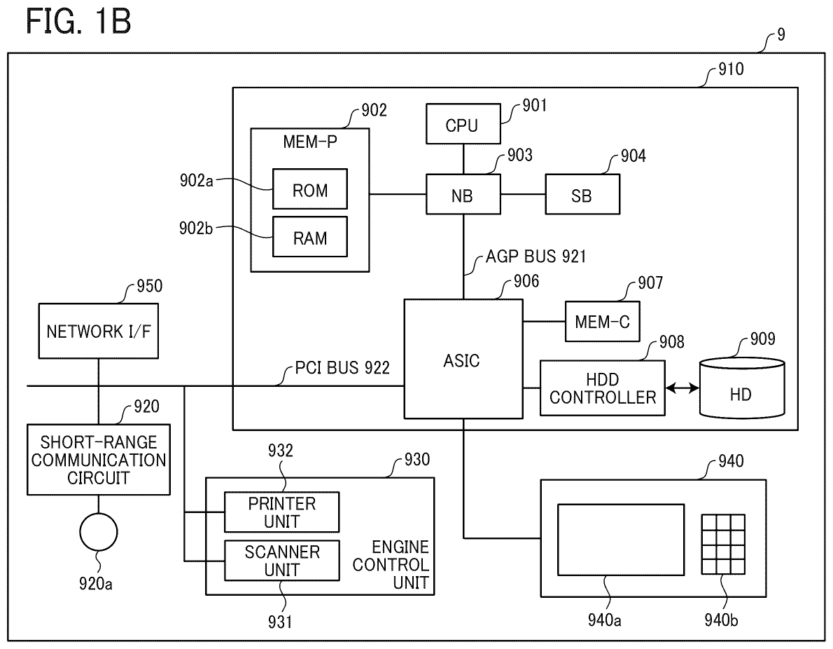

FIG. 2 is a diagram illustrating a functional configuration of a digital front end (DFE) included in a printing system. The DFE 150 is connected to the DFE panel 151 for user interface (UI) display. The system control unit 201 includes a job information processing unit 251, a RIP processing unit 252, a storage unit 253, and a tone correction data generation unit 254. The network I/F unit 202 is an I/F for connecting to the LAN.

The storage unit 203 is a storage device such as a hard disk drive (HDD). The printer I/F unit 204 is an interface for connecting to the printer 101. The user I/F unit 205 is an I/F for the DFE panel 151. The DFE panel 151 is a device for inputting and outputting information from and to the user. The system control unit 201 transmits the job management information and the RIP image together as a print job to the printer 101 via the printer I/F unit 204.

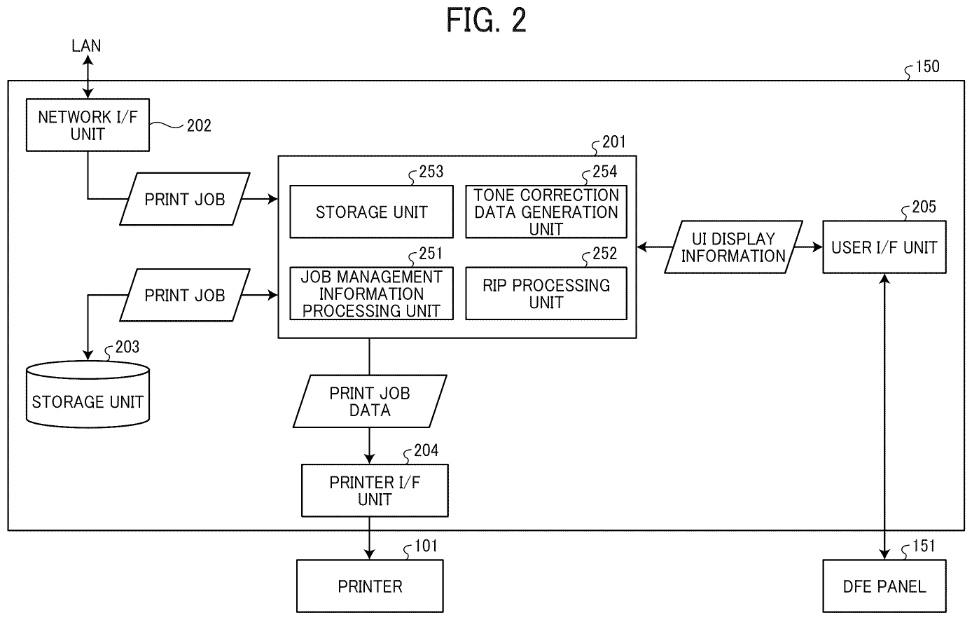

FIG. 3 is a diagram illustrating a functional configuration of a printer included in a printing system. The system control unit 301 is a control unit that manages the entire printer 101 and is equipped with a memory 351, a job processing unit 352, a RIP processing unit 353, and a job management information processing unit 354.

A user I/F unit 302 is an interface for connecting the system control unit 301 and the operation unit 102. A network I/F unit 303 is an interface for connecting the system control unit 301 to a network such as the LAN. An external I/F unit 304 is an interface for other devices.

A HDD 305 is a storage device such as a hard disk.

A mechanism control unit 306 is a control unit for the operation of the printer 101, such as sheet conveyance and the image transfer process. The DFE I/F unit 307, which may be implemented by an interface circuit, is an interface for transferring a RIP image to the externally connected image generation controller (e.g., the DFE 150). The image processing control unit 308 processes the print image transferred by the mechanism control unit 306. The print control unit 309 controls image formation on a printing medium.

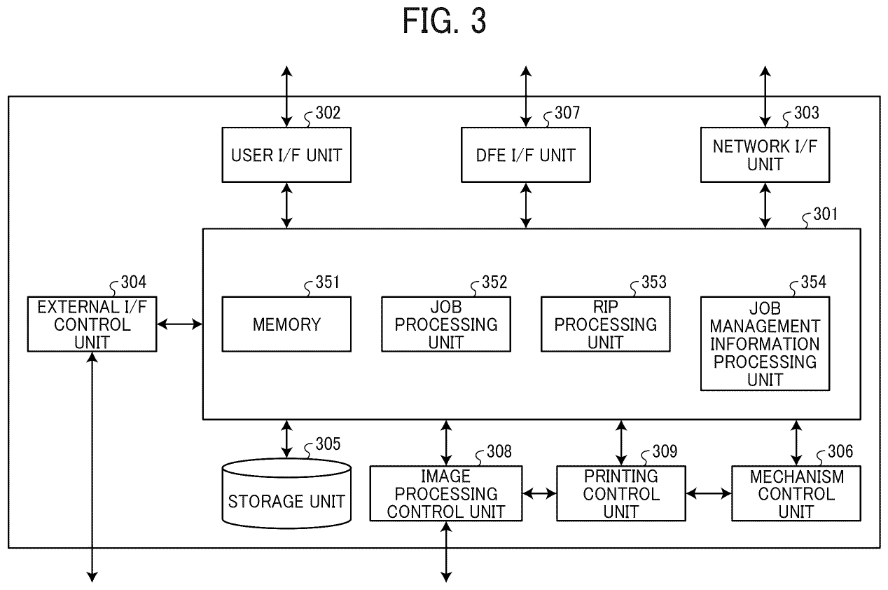

FIG. 4 is a diagram illustrating a configuration of an inspection apparatus. The system control unit 401 is a control unit that controls the overall operation of the inspection apparatus 103. A user I/F unit 402 is an interface for connecting the system control unit 401 and the operation unit 133. The network I/F unit 403 is an interface for connecting the system control unit 301 to a network such as the LAN. The external I/F control unit 404 is an interface for connection to other devices. The storage unit 405 is a storage device such as a hard disk. The mechanism control unit 406 is a control unit for controlling the operation of the inspection apparatus 103 such as sheet conveyance. The printed image reading unit 407 reads print output and outputs an inspection target image. The printed image reading unit (407) is an example of an inspection target image acquisition unit that reads printed material printed by the printer 101, which is an example of a printing apparatus, and acquires a read image, which is an example of an inspection target image.

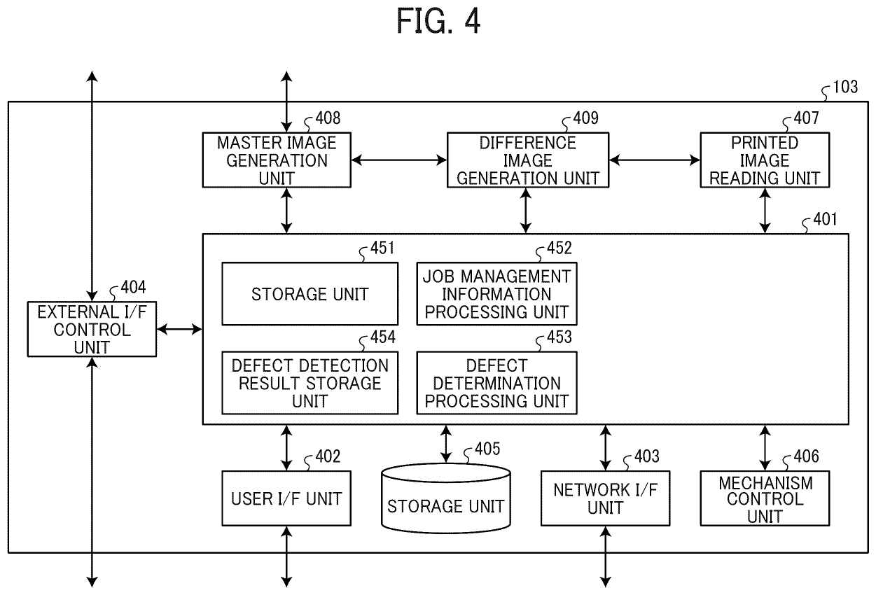

The system control unit 401 receives job management information via the external I/F control unit 404 and stores the job management information in the storage unit 451 within the system control unit 401. Then, the job management information processing unit 452 extracts post-processing information from the job management information illustrated in FIG. 5, and transmits the post-processing information via the external I/F control unit 404 to the stacker 104, which is a post-processing apparatus located downstream of the inspection apparatus 103. Furthermore, the job management information processing unit 452 extracts print management information and transfers the print management information to the master image generation unit 408, the difference image generation unit 409, the printed image reading unit 407, and the mechanism control unit 406. The print management information to be transferred is the job management information illustrated in FIG. 5 from which the post-processing apparatus information is excluded. The master image generation unit 408 generates a master image from the RIP image. That is, the master image generation unit 408 generates a master image that serves as a comparison target for the read image.

The difference image generation unit 409 generates a difference image between the master image and the inspection target image. The system control unit 401 causes the storage unit 451 to store the read image, which is an inspection target image, and the difference image, and notifies the defect determination processing unit 453 and the defect detection result storage unit 454. The defect determination processing unit 453 performs defect determination on the difference image based on a preset defect determination threshold value. That is, the defect determination processing unit 453 is an example of a defect detection unit that detects a defect of a printed material based on a master image and a read image. The defect detection result storage unit 454 stores defect information, including the defect detection level, in a defect information table within the storage unit 405, for each defect detected by the defect determination processing unit 453. The defect detection result storage unit 454 is an example of a defect detection level determination unit that determines a defect detection level for each defect, based on defect detection performed by the defect determination processing unit 453 at multiple defect detection levels.

The defect determination processing unit 453 functions as an example of a defect detection result display unit that, when displaying the defect detection results, presents a mark indicating the position of the defect on the read image and changes the color of the mark according to the defect detection level. With this configuration, by determining the defect detection level for each defect at the defect detection stage, and by changing the display style of the marks indicating the defects (e.g., frame color or line type) according to the defect detection level when displaying the defect detection results, or by displaying the defect detection level adjacent to the marks such as frames, the defect detection results are displayed such that a defect detection level for each defect can be confirmed in a single view. With this configuration, in an inspection system that, when notifying a user of defect detection results, indicates the position of a defect detected based on a preset defect detection level (the defect criteria) using a rectangular frame, the need for the user to select each defect to confirm its defect detection level or to switch the display to indicate detection results for a changed defect detection level is eliminated. This reduces the effort for adjusting the defect detection level.

The operation unit 102 includes a display (e.g., the display panel 940a) to display the defect detection results, such as marks on the inspection target image.

The defect determination processing unit 453 presents a mark indicating the position of the defect on the read image and changes the line type of the mark according to the defect detection level, when displaying the defect detection results. This allows the user to confirm the defect detection level for each defect without designating a defect detection level to switch the display.

Further, for example, the defect determination processing unit 453 may display a mark indicating the position of the defect on the read image and display the defect detection level adjacent to the mark when displaying the defect detection results. This allows the user to confirm the defect detection level for each defect without designating a defect detection level to switch the display.

Furthermore, for example, the defect determination processing unit 453 may set a range for the defect detection level to be displayed and display defects of a specific defect detection level. This allows the user to confirm only the defects that can be detected within a specific range of defect detection levels. In the present embodiment, the process of detecting defects and displaying defect detection results is implemented in the inspection apparatus 103. However, the process may be implemented by the printer 101. Alternatively, the printer 101 and the inspection apparatus 103 may cooperate to perform this process.

FIG. 5 is a table indicating the contents of job management information. The initial value included in the job management information indicates the value at the time of reception by the system control unit 201. The print processing is executed based on the job management information that indicates the processing content of the print job. The job management information is generated for each page of a print image produced by the DFE 150 and the printer body.

The job generation source is information that indicates the job output source, and includes information indicating whether the job is an output job from the DFE 150 or internal data of the printer 101. The generation time is information indicating the date and time when the job generation source generated the job management information. The page ID is an identification number for the print image, incremented by one for each page processed since power-on, and the value is set at the time of print execution. The print side information is used to identify whether the print image is for single-sided printing, or for the front side (double-sided front) or the back side (double-sided back) in double-sided printing.

The sheet ID is identification information for a sheet. For double-sided printing, pages printed on the same sheet share the same sheet ID. The sheet ID is incremented by one for each sheet processed since power-on, and the value is set at the time of print execution. The copy ID is unit-based identification information that is incremented by one upon completion of outputting one copy since power-on, and the value is set at the time of print execution. The job ID is unit-based identification information that is incremented by one upon completion of outputting one job since power-on, and the value is set at the time of print execution. The “sheet type” is information on a type of a sheet used for printing. A sheet size is information indicating the size of a sheet. The “job type” is information indicating whether the print job is subject to defect detection, not subject to defect detection, or involves an insertion sheet (or the like) used for identifying defect detection. The “post-processing apparatus processing information” is setting information for a post-processing apparatus such as a stacker.

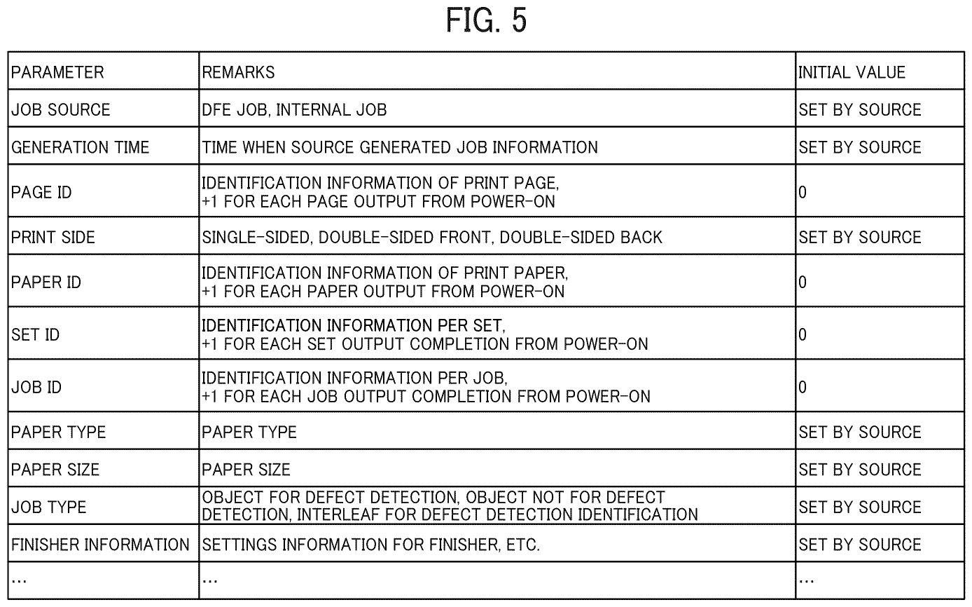

FIG. 6 is a flowchart illustrating a process of detecting defects and displaying defect detection results in a printing system. In step S601, the printed image reading unit 407 acquires a read image, which is an inspection target image. In step S602, the defect determination processing unit 453 sets the defect detection level (detection Lv) to the maximum. In step S603, the defect determination processing unit 453 inspects defects the printed material for defects.

If defects are detected (Step S604: Yes), the defect detection result storage unit 454 stores defect information, including the defect detection level, in the defect information table for each detected defect (step S605). If the defect detection level is not 1 (step S606: No), the defect determination processing unit 453 decrements the defect detection level by 1 to execute the defect inspection again (step S607). In the following description, this process is repeated until the defect detection level reaches 1.

If no defects are detected in the inspection at all defect detection levels (Step S608: Yes), the defect determination processing unit 453 ends the inspection. If defects are detected at one or more defect detection levels (Step S608: No), the defect determination processing unit 453 displays defect detection results.

When displaying the defect detection results, the defect determination processing unit 453 first extracts defect information obtained at defect detection levels equal to or lower than the defect detection level set by the user, from the defect information table (Step S609). The defect determination processing unit 453 displays the read image and presents, on the read image, a mark (e.g., a frame or an arrow) indicating a defect at the position of the defects indicated by the extracted defect information (Step S610). In this case, the defect determination processing unit 453 changes the color or line type of the mark according to the defect detection level, or displays the defect detection level adjacent to the frame.

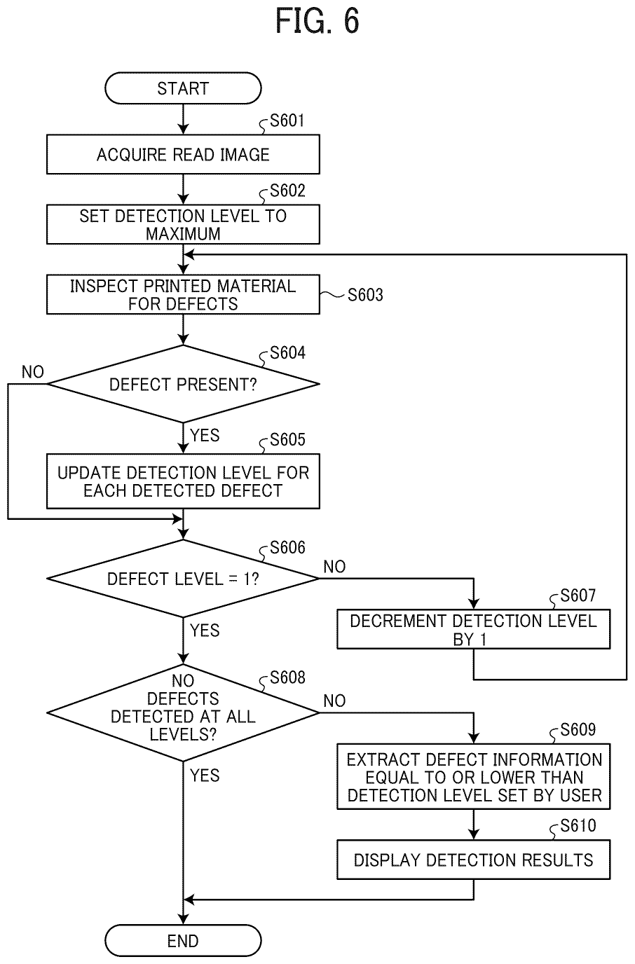

FIG. 7 is a defect information table that stores defect information of a defect detected in a printing system according to an embodiment of the present disclosure. The defect detection result storage unit 454 stores the type, coordinates, and defect detection level of each defect from the defect detection results at the maximum defect detection level. Subsequently, for each subsequent check performed at a lower defect detection level, the defect detection result storage unit 454 iteratively updates the stored defect detection level using the detection results obtained at that level if the defect determination processing unit 453 determines that a defect is still detected at the same location as a previously stored defect. Finally, the defect detection result storage unit 454 updates the defect detection level based on the level-1 defect detection results and determines the final detection level.

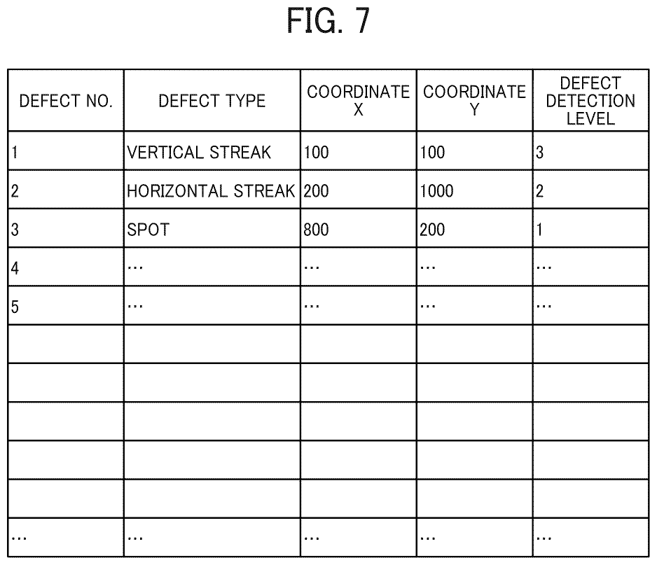

FIG. 8 is a diagram illustrating a screen displaying defect detection results in a printing system. The defect determination processing unit 453 displays defects obtained at defect detection levels equal to or lower than the set defect detection level, on the read image and presents a rectangular frame at the positions of the defects. The default defect detection level is the value specified by the user (e.g., level 3).

For example, when defect detection is performed at the defect detection level 3, the defect determination processing unit 453 displays defects corresponding to the defect detection levels 1 to 3. As the defect detection level increases, a defect having a smaller size and a lighter color can be detected. In this case, the defect determination processing unit 453 may display a frame indicating the position of the defect in a different color for each defect detection level.

In this state, when the defect detection level is changed, the defect determination processing unit 453 displays the detection results of the defects corresponding to the defect detection levels that are equal to or lower than the defect detection level. For example, when the defect detection level is changed to the defect detection level 4, the defect determination processing unit 453 displays a frame having a different color for each defect detection level at the positions of the defects corresponding to the defect detection levels that are equal to or lower than the defect detection level 4.

When the range of the defect detection level to be displayed is specified by the user, i.e., in response to in response to receipt of designation of the range for the defect detection level to be displayed, the defect determination processing unit 453 may display only the defects corresponding to the defect detection levels in the designated range (i.e., specific range). For example, when the defect detection level is set to 2 to 3, the defect determination processing unit 453 displays only the defects corresponding to the defect detection levels 2 the defect and 3. When the defect detection level is set to 3, the defect determination processing unit 453 displays only the defects corresponding to the defect detection level 3. As an example of the colors of the frames indicating the positions of defects, different colors may be applied for respective defect detection levels. Alternatively, the same color with increased color density may be applied for a higher defect detection level.

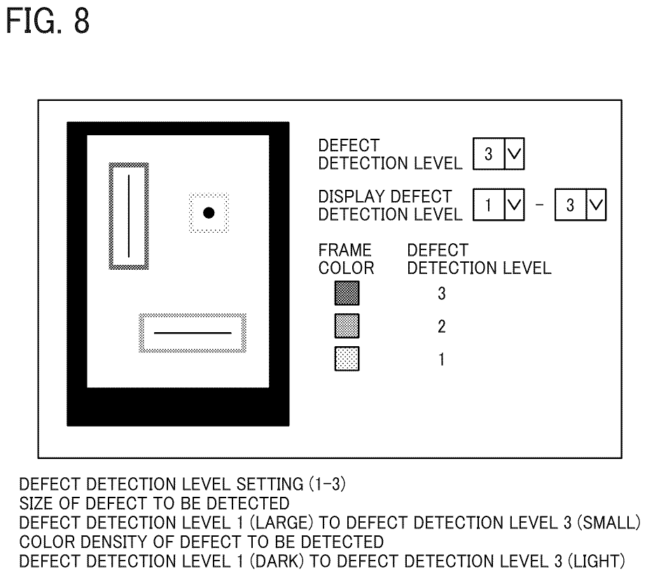

FIG. 9 is a diagram illustrating a screen displaying defect detection results in a printing system. The defect determination processing unit 453 displays defects corresponding to defect detection levels equal to or lower than the set defect detection level on the read image and presents a rectangular frame at the position of the defect. The default defect detection level is the defect detection level set by the user. For example, when defect detection is performed at the defect detection level 3, the defect determination processing unit 453 displays defects corresponding to the defect detection levels 1 to 3. In this case, the defect determination processing unit 453 may change the line types of the frames indicating the positions of defects for respective defect detection levels. In this state, when the defect detection level is changed, the defect determination processing unit 453 will display the detection results of defects obtained at defect detection levels equal to or lower than the changed defect detection level. For example, when the defect detection level is changed to the defect detection level 4, the defect determination processing unit 453 displays a frame having a different line type for each defect detection level at the positions of the defects corresponding to the defect detection levels that are equal to or lower than the defect detection level 4.

When the range of the defect detection level for defects to be displayed is designated, the defect determination processing unit 453 displays only the defects within the designated range (specific range) of the defect detection level. For example, when the defect detection level is set to 2 to 3, the defect determination processing unit 453 displays only the defects corresponding to the defect detection levels 2 and 3. When the defect detection level is set to 3, the defect determination processing unit 453 displays only the defects corresponding to the defect detection level 3. As an example of the line types of the frames indicating the positions of defects, different line types may be applied for respective defect detection levels. Alternatively, the same line type with increased line width may be applied for a higher defect detection level.

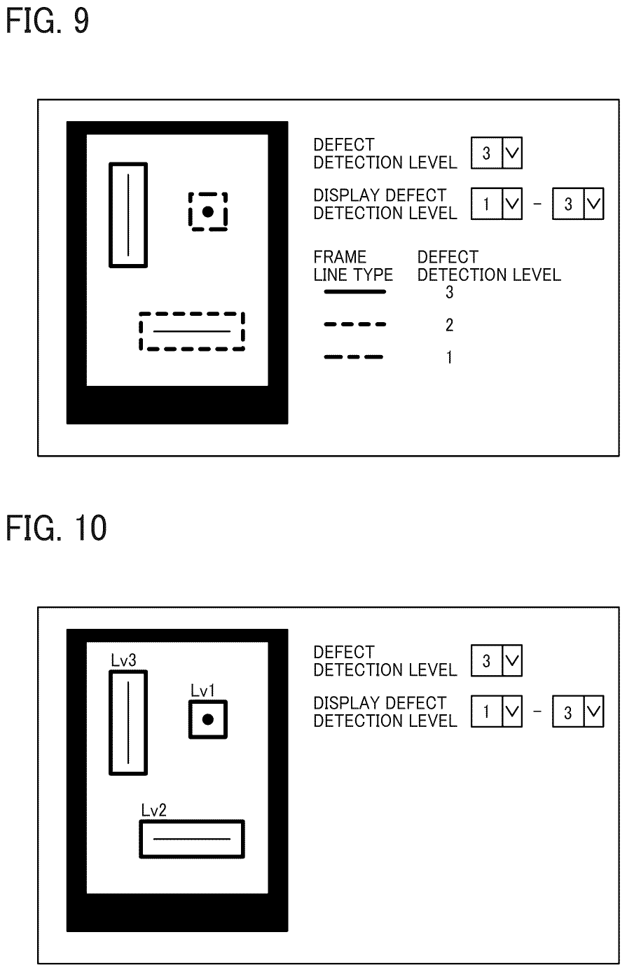

FIG. 10 is a diagram illustrating a screen displaying defect detection results in a printing system. The defect determination processing unit 453 displays defects corresponding to defect detection levels equal to or lower than the set defect detection level on the read image and presents a frame at the positions of the defects. The default defect detection level is the defect detection level set by the user. For example, when defect detection is performed at the defect detection level 3, the defect determination processing unit 453 displays defects corresponding to the defect detection levels 1 to 3. In this case, the defect determination processing unit 453 displays the defect detection level adjacent to the frame indicating the position of the defect.

In this state, when the defect detection level is changed, the defect determination processing unit 453 will display the detection results of defects corresponding to defect detection levels that are equal to or lower than the changed defect detection level. For example, when the defect detection level is changed to the defect detection level 4, the defect determination processing unit 453 displays a frame and a detection level for each defect detection level at the positions of the defects corresponding to the defect detection levels that are equal to or lower than the defect detection level 4. When the range of the defect detection level for defects to be displayed is designated, the defect determination processing unit 453 displays only the defects within the designated range (specific range) of the defect detection level. For example, when the defect detection level is set to 2 to 3, the defect determination processing unit 453 displays only the defects corresponding to the defect detection levels 2 and 3. When the defect detection level is set to 3, the defect determination processing unit 453 displays only the defects corresponding to the defect detection level 3.

With the printing system according to the present embodiment, in an inspection system that, when notifying a user of defect detection results, indicates the position of a defect detected based on a preset defect detection level (the defect criteria) using a rectangular frame, the need for the user to select each defect to confirm its defect detection level or to switch the display to indicate detection results for a changed defect detection level is eliminated. This reduces the effort for adjusting the defect detection level.

The program executed at the inspection apparatus 103 according to the present embodiment is preinstalled in, for example, a ROM.

The program executed by the inspection apparatus 103 according to the present embodiment may be stored in a computer-readable recording medium, such as a compact disc read-only memory (CD-ROM), a flexible disk (FD), a compact disc-recordable (CD-R), and a digital versatile disk (DVD), in an installable or executable file format, to be provided.

Alternatively, the program executed by the inspection apparatus 103 according to the embodiments described above may be stored on a computer connected to a network such as the Internet so that the program can be downloaded through the network and provided. Still, alternatively, the program executed by the inspection apparatus 103 according to the embodiments described above may be configured to be provided or distributed via a network such as the Internet.

In the inspection apparatus 103 according to the present embodiment, the program executed in the apparatus has a module configuration including the above-described units, that is, the system control unit 401, the mechanism control unit 406, the printed image reading unit 407, the master image generation unit 408, and the difference image generation unit 409. As actual hardware, a processor such as a CPU reads the program from the ROM and executes the program, and as a result, the above units are loaded into a main storage device, and the system control unit 401, the mechanism control unit 406, the printed image reading unit 407, the master image generation unit 408, and the difference image generation unit 409 are generated in the main storage device.

Aspects of the present disclosure are, for example, as follows.

### Aspect 1

A printing system includes a printer (101) to print image data to output a printed material; an inspection apparatus (103) including a reader to read the printed material output from the printer (101) to acquire an inspection target image; and circuitry configured to detect defects, according to multiple defect detection levels, from the inspection target image on the printed material based on the inspection target image and a master image to be compared with the inspection target image; determine, for each of the defects, one of the multiple defect detection levels; and display, on the inspection target image, a mark indicating a position of each of the defects in the inspection target image on the printed material and having a color changed according to the one of the multiple defect detection levels determined.

### Aspect 2

In the printing system according to Aspect 1, the defect detection result display unit is further configured to display the mark having a line type changed according to the one of the multiple defect detection levels determined.

### Aspect 3

In the printing system according to Aspect 1 or 2, the defect detection result display unit is further configured to display the one of the multiple defect detection levels on a portion adjacent to the mark for each of the defects.

### Aspect 4

In the printing system according to any one of Aspects 1 to 3, the defect detection result display unit is further configured set a range of the multiple defect detection levels to be displayed and display the defects corresponding to the multiple defect detection levels within the range.

### Aspect 5

The printing system according to any one of Aspects 1 to 4 further includes an operation unit including a display to display the mark on the inspection target image.

### Aspect 6

A printing method includes printing image data to output a printed material; outputting the printed material; reading the printed material output from a printer to acquire an inspection target image; detecting defects, according to multiple defect detection levels, from the inspection target image on the printed material based on the inspection target image and a master image to be compared with the inspection target image; determining, for each of the defects, one of the multiple defect detection levels; and displaying, on the inspection target image, a mark indicating a position of each of the defects in the inspection target image on the printed material and having a color changed according to the one of the multiple defect detection levels determined.

### Aspect 7

A non-transitory computer-readable medium storing a program which, when executed by a processor, causes the processor to perform a printing method including: printing image data to output a printed material; outputting the printed material; reading the printed material output from a printer to acquire an inspection target image; detecting defects, according to multiple defect detection levels, from the inspection target image on the printed material based on the inspection target image and a master image to be compared with the inspection target image; determining, for each of the defects, one of the multiple defect detection levels; and displaying, on the inspection target image, a mark indicating a position of each of the defects in the inspection target image on the printed material and having a color changed according to the one of the multiple defect detection levels determined.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A printing system comprising:
a printer to print image data to output a printed material;
an inspection apparatus including a reader to read the printed material output from the printer to acquire an inspection target image; and
circuitry configured to:
detect defects, according to multiple defect detection levels, from the inspection target image on the printed material based on:
the inspection target image; and
a master image to be compared with the inspection target image;
determine, for each of the defects, one of the multiple defect detection levels; and
display, on the inspection target image, a mark:
indicating a position of each of the defects in the inspection target image on the printed material; and
having a color changed according to the one of the multiple defect detection levels determined.

2. The printing system according to claim 1, wherein:
the circuitry is further configured to display the mark having a line type changed according to the one of the multiple defect detection levels determined.

3. The printing system according to claim 1, wherein:
the circuitry is further configured to display the one of the multiple defect detection levels on a portion adjacent to the mark for each of the defects.

4. The printing system according to claim 1, wherein:
the circuitry is further configured to:
set a range of the multiple defect detection levels to be displayed; and
display the defects corresponding to the multiple defect detection levels within the range.

5. The printing system according to claim 1, further comprising an operation unit including a display to display the mark on the inspection target image.

6. A printing method comprising:
printing image data to output a printed material;
outputting the printed material;
reading the printed material output from a printer to acquire an inspection target image;
detecting defects, according to multiple defect detection levels, from the inspection target image on the printed material based on:
the inspection target image; and
a master image to be compared with the inspection target image;
determining, for each of the defects, one of the multiple defect detection levels; and
displaying, on the inspection target image, a mark:
indicating a position of each of the defects in the inspection target image on the printed material; and
having a color changed according to the one of the multiple defect detection levels determined.
